(19) United States
(12) Patent Application Publication
(10) Pub. No.: US 2025/0122917 A1
(43) Pub. Date: Apr. 17, 2025

(54) Flange integrated tuned mass damper

(71) Applicant: Zhejiang University of Technology, Hangzhou City (CN)

(72) Inventors: Zhenyu DING, Hangzhou City (CN); Cheng CHEN, Hangzhou City (CN); Shijing CAO, Hangzhou City (CN); Zhiqiang LI, Hangzhou City (CN)

(21) Appl. No.: 18/911,853

(22) Filed: Oct. 10, 2024

(30) Foreign Application Priority Data
Oct. 12, 2023 (CN) 202311317631.1

(51) Int. Cl. F16F 7/116

(52) U.S. Cl. CPC F16F 7/116; F16F 2224/0208; F16F 2230/0005; F16F 2232/08; F16F 2238/02

(57) ABSTRACT

A flange integrated tuned mass damper, including a main shaft structure, a plurality of wire rope isolators, and a mass ring. Flange plates are installed on the main shaft structure, and the mass ring is located below and connected to the flange plates through the plurality of wire rope isolators uniformly distributed in a circumferential direction. The plurality of wire rope isolators are uniformly distributed outside the main shaft structure in the circumferential direction, and the wire rope isolators directly carries the mass ring and are in a tensile deformation state, with both spring and damper functions. The wire rope isolators can bear tensile, compressive, rolling, and shearing loads, thus ensuring the degree of freedom of the mass ring in any horizontal direction.

### TECHNICAL FIELD

The present disclosure belongs to the field of vibration control, and relates to a flange integrated tuned mass damper.

### BACKGROUND

Electric energy is a necessary energy source for production and life today. At present, the largest power system in the world has been built in China, with the installed capacity of power generation of 2.47 billion kilowatts. With 1.11 billion kilowatts of coal-fired power installed by the end of 2021, the share of total installed generating capacity has declined to 46.7 percent. The construction of hydropower and nuclear power has been steadily advanced, and new energy sources have maintained a rapid development momentum. At present, more than 60,000 transformer substations have been put into operation. In the composition of the electrical power system, the transformer substation is the key node of power grid transmission and distribution, which undertakes the task of exchange, concentration and distribution of voltages and currents, and plays an important role in the electrical power system.

The framework of the transformation substation is mainly a steel structure, and the structural member is mainly a steel pipe or lattice, which is equipped with the frame lightning rod. The frame lightning rod is often a highly flexible structure with a large height-diameter ratio, which is easily affected by wind load during operation. Under certain circumstances, the lightning conductor resonates under the wind-induced action to cause crosswind induced vibration, which may cause excessive local stress and accumulation of fatigue damage of the lightning conductor. Especially at the root joint of the lightning rod, cracking or even collapse may be caused, which is easy to cause safety accidents. Therefore, it is of a great significance to study the wind-induced vibration of lightning rod and develop a vibration reduction device to ensure the safe and stable operation of the lightning rod.

The tuned mass damper is mainly composed of a mass block, a spring, and a damping system. An operating principle of the tuned mass damper is that the main system will be forced to vibration when vibrating under the external excitation. When the frequency of the external excitation is equal to or similar to that of the main system, the main system shows intense resonance, and obvious vibration may be caused even if the excitation force is small. A TMD system is added, and the setting of parameters makes the inherent frequency of the TMD similar to the control frequency of the main system. When the control frequency of the main system is excited to generate resonance under the action of wind, the TMD system will produce resonance behavior opposite to the main structure due to the inertia of the mass block and the restoring force of the spring. In this way, in the process of vibration, part of the vibration energy of the main system caused by external excitation is converted into the kinetic energy of the TMD vibrator, part of the vibration energy is converted into the elastic potential energy of the spring, and another part of the energy is dissipated through the damper of the TMD. Therefore, the TMD system can restrain the vibration of the main system to effectively reduce the amplitude of the main system.

TMD (Tuned mass damper) has been widely used in high-rise buildings or equipment, as most of the high-rise equipment has a large diameter, the traditional TMD can better meet the operating conditions. However, due to the small diameter of the lightning rod, the TMD cannot be directly installed inside or outside the lightning rod, and thus a TMD vibration reduction device which can be installed on equipment with small diameter and meet the vibration reduction requirements is needed. The above working conditions can be better met through reducing the volume of the TMD through enlarging the flange plate and removing the suspension device. A Q-wire rope isolator is used to replace a spring and a damper in the traditional TMD, which can further reduce the volume of the whole device. Moreover, as an elastic element, the wire rope can resist high temperature and corrosion, is not affected by oil stains and organic solvents, can still operate normally under various stress conditions, and has both stiffness and damping effects, and thus the requirements of vibration reduction can be well satisfied. Therefore, the flange integrated tuned mass damper has broad prospect in vibration control of high-rise equipment with small diameter, such as lightning conductor.

### SUMMARY

In order to solve the technical problem in the prior art, the present disclosure provides a vibration reduction device of a flange integrated tuned mass damper, which is used for vibration reduction control of high-rise equipment with a smaller diameter such as a lightning conductor, and the specific technical solution is as follows.

A flange integrated tuned mass damper includes a main shaft structure, a plurality of wire rope isolators and a mass ring. Flange plates are installed on the main shaft structure, and the mass ring is located below and connected to the flange plates through the plurality of wire rope isolators uniformly distributed in a circumferential direction. The plurality of wire rope isolators are uniformly distributed outside the main shaft structure in the circumferential direction.

Further, the main shaft structure is composed of an upper shaft and a lower shaft and are formed by splicing the flange plates respectively mounted to the upper shaft and the lower shaft; each flange plate is provided with a plurality of bolt holes uniformly distributed in the circumferential direction, and then the flange plates are connected through bolt-nut-washer assemblies which are connected aligned the bolt holes.

Further, a peripheral edge of each flange plate is uniformly provided with a plurality of bolt holes with an amount corresponding to that of the wire rope isolators.

Further, mounting plates are welded to an upper edge of the mass ring, and bolt holes are formed in the mounting plates.

Further, an amount of the mounting plates is the same as an amount of the wire rope isolators, positions of the mounting plates correspond to positions of the wire rope isolators, and the amount of the mounting plates and the amount of the wire rope isolators are not less than 3.

Further, upper ends of the wire rope isolators are connected to the bolt holes in the peripheral edge of the flange plates through the bolt-nut-washer assemblies, and lower ends of the wire rope isolators are connected to the mounting plates at corresponding positions through the bolt-nut-washer assemblies.

Further, the wire rope isolators adopts stainless-steel wires as elastic elements.

Further, the wire rope isolators are drum-shaped.

Compared with the prior art, the present disclosure has the following beneficial effects:

According to the flange integrated tuned mass damper provided by the present disclosure, a suspension device is replaced by the enlarged flange plate, and a spring and a damping system are replaced with the wire rope isolators, such that complexity of the device is greatly reduced, a space required for installing the device is reduced, and the device can be used for vibration reduction of high-rise equipment with a smaller diameter. Meanwhile, the wire rope isolator employs stainless-steel wire rope as an elastic element, which has good dry friction and high damping characteristics, is corrosion-resistant, and can operate normally under harsh working conditions without frequent replacement and maintenance. The complete device has the advantages of small floor space, simple structure, convenience in installation, and no need for frequent maintenance and replacement.

### BRIEF DESCRIPTION OF THE DRAWINGS

FIG. 1 is a schematic diagram of an overall structure of a flange integrated tuned mass damper according to an embodiment of the present disclosure;

FIG. 2 is a schematic diagram of a partially enlarged structure of a flange integrated tuned mass damper according to an embodiment of the present disclosure;

FIG. 3 is a top view of FIG. 1;

FIG. 4 is a bottom view of FIG. 1.

In the drawings: 1—main shaft structure; 2—bolt-nut-washer assembly; 3—flange plate; 4—wire rope isolator; 5—mounting plate; 6—mass ring.

### DETAILED DESCRIPTION OF THE EMBODIMENTS

In order to make the objectives, technical solutions and advantages of the present disclosure more clearly, the present disclosure is further described in detail below with reference to the accompanying drawings and embodiments.

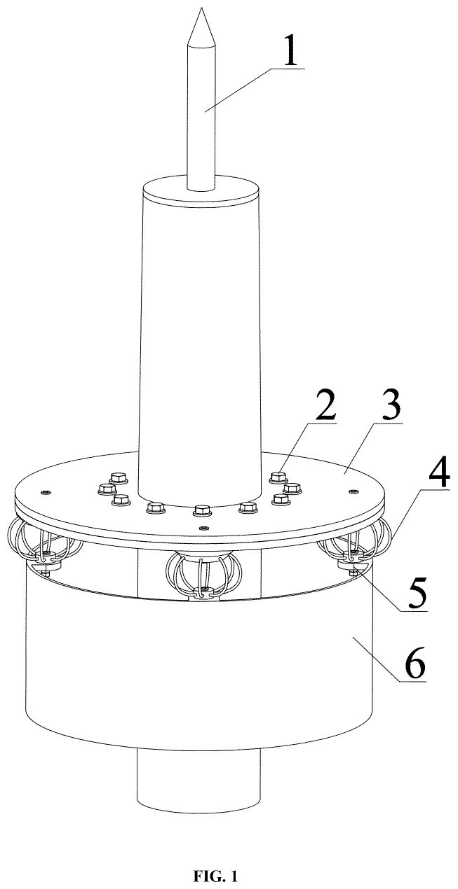

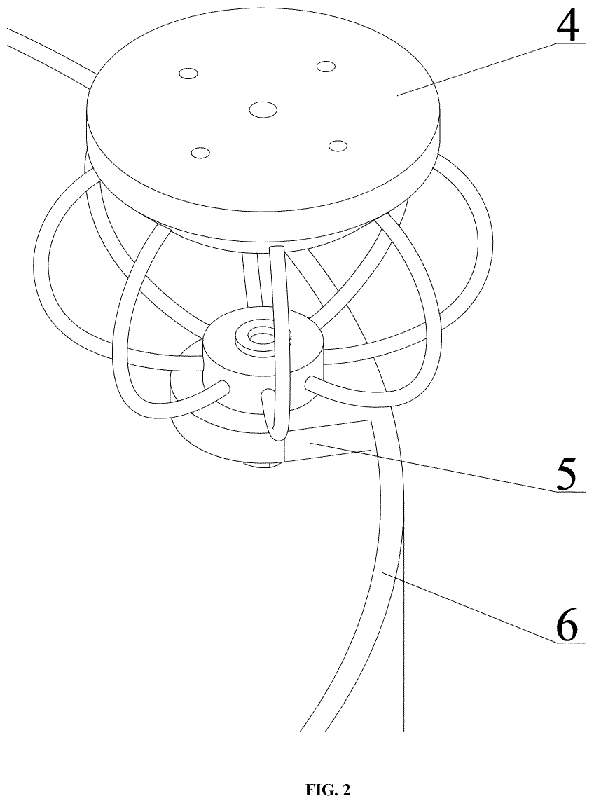

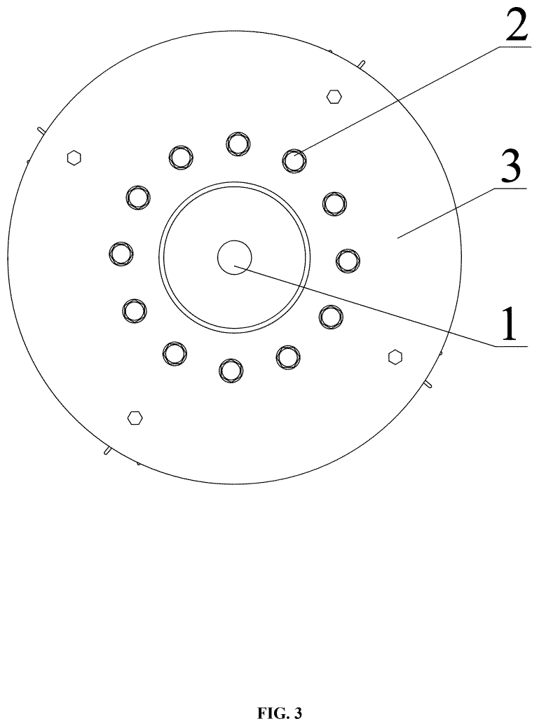

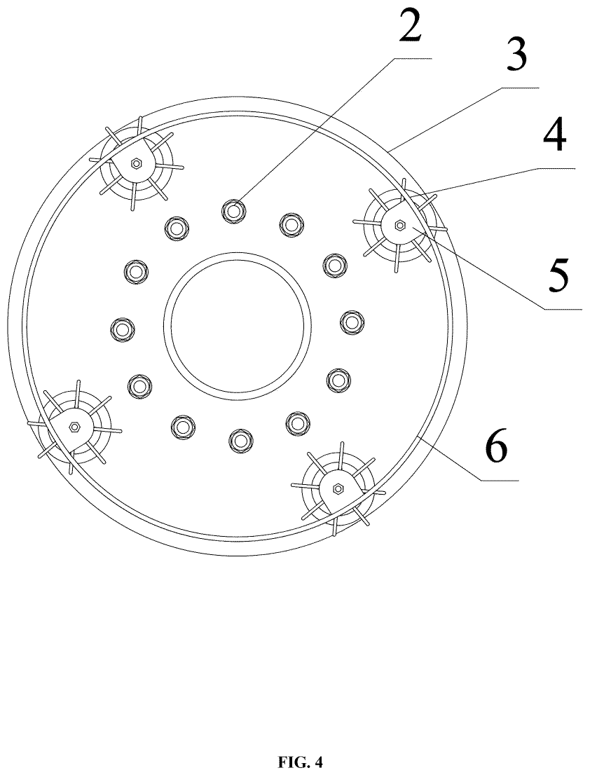

As shown in FIG. 1 to FIG. 4, an embodiment of the present disclosure provides a flange integrated tuned mass damper, including a main shaft structure 1, a plurality of wire rope isolators 4 and a mass ring 6. Flange plates 3 are installed on the main shaft structure 1, and the mass ring 6 is located below and connected to the flange plates through the plurality of wire rope isolators 4 uniformly distributed in a circumferential direction. The plurality of wire rope isolators 4 are uniformly distributed outside the main shaft structure 1 in the circumferential direction, and the wire rope isolators 4 directly carry the mass ring 6 and are in a tensile deformation state, with both spring and damper functions. Meanwhile, the wire rope isolators 4 can bear tensile, compressive, rolling, and shearing loads, thus ensuring degrees of freedom of the mass ring 6 in any horizontal direction.

The main shaft structure 1 is composed of an upper shaft and a lower shaft and is formed by splicing the flange plates respectively mounted to the upper shaft and the lower shaft; each flange plate 3 is provided with a plurality of bolt holes uniformly distributed in the circumferential direction, and then the flange plates 3 are connected through bolt-nut-washer assemblies 2 in a case where the bolt holes in the flange plates are in alignment.

A peripheral edge of each flange plate 3 is uniformly provided with a plurality of bolt holes with an amount corresponding to that of the wire rope isolators 4.

Mounting plates 5 are welded to an upper edge of the mass ring 6, and bolt holes are formed in the mounting plates 5. An amount of the mounting plates 5 is the same as an amount of the wire rope isolators 4, positions of the mounting plates correspond to positions of the wire rope isolators 4, and the amount of the mounting plates 5 and the amount of the wire rope isolators 4 are not less than 3.

The wire rope isolators 4 are drum-shaped, upper clamping plates of the wire rope isolators 4 are connected to the bolt holes in the peripheral edge of the flange plates 3 through the bolt-nut-washer assemblies 2, and lower clamping plates of the wire rope isolators 4 are connected to corresponding mounting plates 5 through the bolt-nut-washer assemblies 2.

In the description of the present disclosure, it should be noted that the orientation or positional relationship indicated by terms “top”, “bottom”, “uniform distribution”, and “outside” is based on the orientation or positional relationship shown in the drawings, or the orientation or position relationship of the product in use, which is only for convenience of description of the present disclosure and simplification of description rather than indicating or implying that the device or element referred to must have a particular orientation, be constructed and operate in a particular orientation, and thus are not to be construed as limiting the present disclosure.

The above is only the preferred embodiment of the present disclosure, and is not intended to limit the present disclosure in any form. Although the embodiments of the present disclosure have been described in detail herein before, those skilled in the art still can modify the technical solutions recorded in the above examples, or replace some technical features by equivalents. Any modification, equivalent replacement, etc. made within the spirit and principle of the present disclosure should be included in the scope of protection of the present disclosure.

1. A flange integrated tuned mass damper, comprising a main shaft structure (1), a plurality of wire rope isolators (4) and a mass ring (6), wherein flange plates (3) are installed on the main shaft structure (1), and the mass ring (6) is located below and connected to the flange plates through the plurality of wire rope isolators (4) uniformly distributed in a circumferential direction; and the plurality of wire rope isolators (4) are uniformly distributed outside the main shaft structure (1) in the circumferential direction.

2. The flange integrated tuned mass damper according to claim 1, wherein the main shaft structure (1) is composed of an upper shaft and a lower shaft and are formed by splicing the flange plates respectively mounted to the upper shaft and the lower shaft; each flange plate (3) is provided with several first bolt holes uniformly distributed in the circumferential direction, the flange plates (3) are connected through bolt-nut-washer assemblies (2) in a case where the first bolt holes in the flange plates are in alignment.

3. The flange integrated tuned mass damper according to claim 1, wherein a peripheral edge of each flange plate (3) is uniformly provided with a plurality of second bolt holes with an amount corresponding to that of the wire rope isolators (4).

4. The flange integrated tuned mass damper according to claim 3, wherein mounting plates (5) are welded to an upper edge of the mass ring (6), and third bolt holes are formed in the mounting plates (5).

5. The flange integrated tuned mass damper according to claim 4, wherein an amount of the mounting plates (5) is the same as an amount of the wire rope isolators (4), positions of the mounting plates correspond to positions of the wire rope isolators (4), and the amount of the mounting plates (5) and the amount of the wire rope isolators (4) are not less than 3.

6. The flange integrated tuned mass damper according to claim 5, wherein upper ends of the wire rope isolators (4) are connected to the second bolt holes in the peripheral edge of the flange plates (3) through the bolt-nut-washer assemblies (2), and lower ends of the wire rope isolators (4) are connected to the mounting plates (5) at corresponding positions through the bolt-nut-washer assemblies (2).

7. The flange integrated tuned mass damper according to claim 1, wherein the wire rope isolators (4) adopt stainless-steel wires as elastic elements.

8. The flange integrated tuned mass damper according to claim 1, wherein the wire rope isolators (4) are drum-shaped.
